(19) United States
(12) Patent Application Publication
(10) Pub. No.: US 2019/0073616 A1
(43) Pub. Date: Mar. 7, 2019

(54) CUSTOMER INTERACTION IDENTIFICATION AND ANALYTICS SYSTEM

(71) Applicant: Walmart Apollo, LLC, Bentonville, AR (US)

(72) Inventors: Steven Lewis, Bentonville, AR (US); Nicholaus A. Jones, Fayetteville, AR (US); Matthew Biermann, Fayetteville, AR (US)

(21) Appl. No.: 16/124,432

(22) Filed: Sep. 7, 2018

Related U.S. Application Data
(60) Provisional application No. 62/555,388, filed on Sep. 7, 2017.

(51) Int. Cl. G06Q 10/06; G06Q 30/02

(52) U.S. Cl. CPC G06Q 10/06311; G06Q 30/0201

(57) ABSTRACT

Embodiments relate to systems and methods for customer interaction identification and analytics. A system can include a plurality of monitoring devices, a task management system and a customer interaction identification and analytics module. The plurality of monitoring devices can be configured for wear or handheld use and include a housing, a portable electronic computing device, and at least one sensor to sense activity data regarding a person wearing or holding the monitoring device. The task management system is communicatively coupled the plurality of monitoring devices to present at least one task to be completed in a retail environment, the at least one task associated with a temporal reference and a location in the retail environment. The customer interaction identification and analytics module, includes a gesture recognition database, communicatively coupled with the task management system and the plurality of monitoring devices.

### RELATED APPLICATION

The present application claims the benefit of U.S. Provisional Application No. 62/555,388 filed Sep. 7, 2017, which is hereby incorporated herein in its entirety by reference.

### TECHNICAL FIELD

Embodiments relate generally to systems, methods, and monitoring devices for identification, tracking, and analytics of in-person interactions with customers.

### BACKGROUND

Providing quality service and positive interactions with customers and the public at large is an important goal for many business entities. Accordingly, businesses have routinely sought to better understand interactions of representatives with members of the public. Businesses have needed this type of information to ensure adequate staffing, training, and incentives are in place so that operational efficiency and the reputation of the business can be continually improved.

These needs are especially acute for entities that work with independent contractors to fulfill requests. Often, these agents of a business entity will interact with customers within a retail environment. Interactions between these agents and the customers of the retail environment may have an effect on the reputation both on the business entity that the agent represents, and the retail store itself. It has been difficult to obtain information about individual representative tasks, movements, and interactions with the public. This has been the case with respect to information about intermittent instances of customer assistance or contact. Likewise, finding ways to encourage, incentivize and understand interactions with the public has been a challenge.

Accordingly, the ability to readily identify, track, record and analyze representative interactions with customers in a retail environment is desired.

### SUMMARY

In an embodiment, a customer interaction identification and analytics system includes a plurality of monitoring devices, a retail task management system and a customer interaction identification and analytics module. The plurality of monitoring devices is configured for wear or handheld use. Each monitoring device includes a housing, a portable electronic computing device coupled with the housing having a user interface, and at least one sensor coupled with the portable electronic computing device. The at least one sensor is configured to sense activity data regarding a representative wearing or holding the monitoring device. The task management system is communicatively coupled with each of the plurality of monitoring devices to present, on the user interface, at least one task to be completed in a retail environment. The at least one task is associated with a temporal reference and a location in the retail environment. The customer interaction identification and analytics module, includes a gesture recognition database, communicatively coupled with the task management system and the plurality of monitoring devices. The customer interaction identification and analytics module receives activity data from the at least one sensor of one of the plurality of monitoring devices. The received activity data is related to the representative wearing or holding the one of the plurality of monitoring devices. The customer interaction identification and analytics module analyzes the received activity data with respect to data in the gesture recognition database, the at least one task, the temporal reference and the location to determine if the activity of the representative is associated with an interaction with a customer in the retail environment. The customer interaction identification and analytics module creates a record of any activity of the representative determined to be an interaction with a customer in the retail environment.

In an embodiment, a method of identifying and analyzing customer interactions includes providing a monitoring device configured for wear or handheld use, including: a housing, a portable electronic computing device coupled with the housing and having a user interface, and at least one sensor, to a representative in a retail environment. The method includes presenting at least one task to be completed by the representative in a retail environment on the user interface. The at least one task is associated with a temporal reference and a location in the retail environment. The method includes sensing activity of the representative via the at least one sensor to produce sensed activity data. The method includes analyzing the sensed activity data with respect to data in a gesture recognition database, the at least one task, the temporal reference and the location to determine if the activity of the representative is associated with an interaction with a customer in the retail environment. The method includes creating a record if the activity of the representative is determined to be associated with an interaction with a customer in the retail environment.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a customer interaction identification and analytics system, according to an embodiment.

FIG. 2 shows a representative equipped with handheld and wearable monitoring devices engaged in a customer interaction in a retail environment, according to an embodiment.

FIG. 3 is an example of a handheld monitoring device that is configured to be used in a customer interaction identification system, according to an embodiment.

FIG. 4 is an example of a wearable monitoring device that is configured to be used in a customer interaction identification system, according to an embodiment.

FIG. 5 is an example of task data for a customer interaction identification and analytics system, according to an embodiment.

FIG. 6 is a schematic diagram of a retail environment in which a customer interaction identification and analytics system is being used, according to an embodiment.

FIG. 7 is an example of activity data for a customer interaction identification and analytics system, according to an embodiment.

FIG. 8 is an example table of predefined gestures for a customer interaction identification and analytics system, according to an embodiment.

FIG. 9 is a flowchart of a customer interaction identification and analytics module, according to an embodiment.

FIG. 10 is a flowchart of a method of identifying and analyzing customer interactions, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Embodiments relate to systems and methods for identification, tracking, and analytics of business representative interactions with customers in a retail environment. Embodiments of systems and methods discussed herein can be used in many ways, including using wearable or handheld monitoring devices that move with the body of the representative throughout their time in the retail environment and generate data that can be analyzed, to identify possible interactions between the representative and customers in retail environments.

For purposes of this application, the term “retail environment” generally includes any retail store, business, retailer, or physical place of commerce. At times in this application, the terms “retail environment,” “store,” “retailer,” and “defined retail environment” are used interchangeably. These terms should generally be broadly construed in a non-limiting manner.

The retail environments in which the disclosed systems and methods can be used include virtually any retail outlet, including a physical, brick-and-mortar storefront; or some other setting or location via which a customer may purchase or obtain products. In some embodiments, the retail environment is a wholesale club or other membership-based retail environment. Though only a single defined retail environment is largely discussed in the examples used herein, in some cases, the systems and methods can include a plurality of retail environments. For example, data from one or a plurality of retail environments can be aggregated, analyzed and applied to one or a plurality of other retail environments. In some embodiments, data from one or a plurality of retail environments can be aggregated, analyzed and/or applied in conjunction with data related to representative and customer shopping behaviors, patterns or other factors.

The retail environment can be associated with a retailer, such as by being a subsidiary, franchise, owned outlet, or other affiliate of the retailer. The retailer can be or have a home office or headquarters of a company, or some other affiliate, which often is located apart from the defined retail environment itself. In some embodiments, facilities or functions associated with the broader retailer can be partially or fully co-located with the defined retail environment. For example, the retailer and a brick-and-mortar retail environment can be co-located.

For purposes of this application, “representatives” can include independent contractors, retail associates, employees, workers, personnel, stock/inventory workers, greeters, cashiers, customer service personnel, maintenance workers, managers, pharmacists, order fillers, sales associates, technicians, cart pushers, produce workers, deli workers, bakery workers, electronics department workers, and various other workers or agents which have may have customer contact within a retail environment during the performance of one or more tasks.

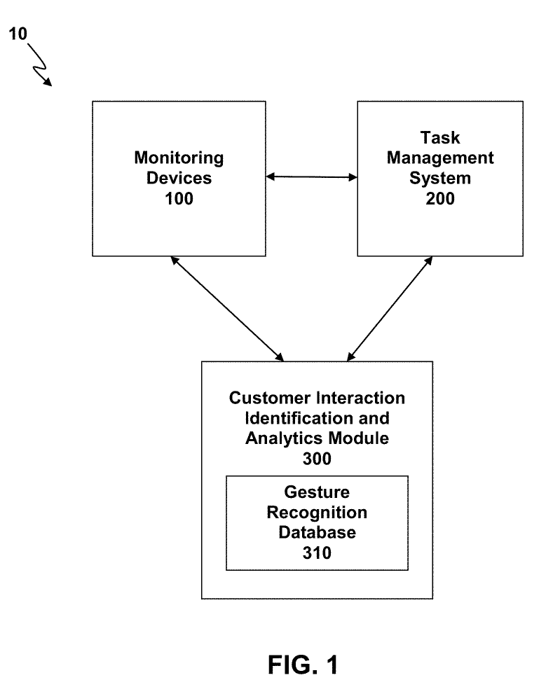

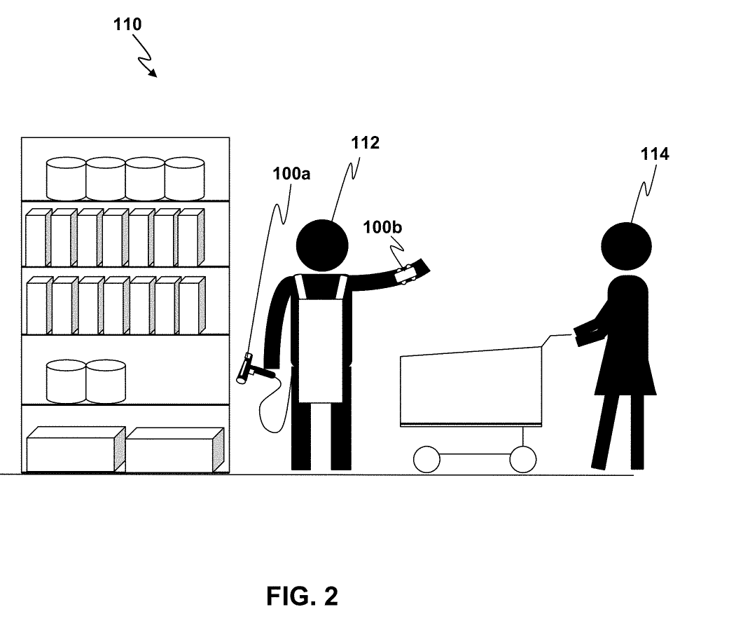

Referring to FIG. 1, an embodiment of a customer interaction identification and analytics system 10 is shown. The customer interaction identification and analytics system 10 generally includes a plurality of monitoring devices 100, a task management system 200, and a customer interaction identification and analytics module 300. In embodiments, the monitoring devices 100 include a plurality of devices that are each made for representative to wear or to be used in a handheld manner by a representative. Examples of such devices are depicted in, but not limited in any way by, FIGS. 2-4 and their corresponding descriptions. In general, the monitoring devices 100 are each configured to sense activity data regarding a person wearing or holding the respective monitoring device(s) 100.

The task management system 200 of FIG. 1 is communicatively coupled with each of the monitoring devices 100. The system 200 presents information related to one or more tasks that a particular representative is assigned to perform. This information can be displayed on a user interface of the monitoring device 100 in some cases. The system 200 can display at least one task to be completed, a temporal reference indicative of the times during which the task should be performed, and a location in which the task(s) should be completed. In some embodiments, system 200 can include computing devices, microprocessors, modules, or other computer or computing devices.

The customer interaction identification and analytics module 300 of FIG. 1 is communicatively coupled with the task management system 200 and the plurality of monitoring devices 100. The customer interaction identification and analytics module 300 includes a gesture recognition database 310. The module 300 receives activity data from the monitoring devices 100 related to the representative wearing or holding the monitoring device(s) and analyzes it. The module 300 analyzes the received activity data with respect to data in the gesture recognition database 310 and the task-related information to determine if the activity of the representative being monitored is associated with an interaction with a customer and, if so, a corresponding record is created.

Referring to FIG. 2, a retail environment 110 is shown where a representative 112, depicted with multiple monitoring devices 100a and 100b, is engaging in a customer interaction with a customer 114. Monitoring devices 100a and 100b can be interchangeably, or more generally, referred to as monitoring devices 100 at various times in this disclosure as well. In

FIG. 2, monitoring device 100a is shown as a handheld device and monitoring device 100b is shown as a wearable device. In general, any number of wearable and/or handheld monitoring devices 100 can be associated with a particular representative 112 and any number of representatives 112 can be associated with monitoring devices 100 in a system 10 or related method. In some embodiments, each representative 112 will only be associated with a single wearable or handheld monitoring device 100. In some embodiments, certain representatives 112 will be equipped with a plurality of wearable or handheld monitoring devices 100. In embodiments like the one shown, systems and methods are contemplated for tracking activity data of representatives 112 and analyzing those activities to identify when a representative 112 is or was interacting with a customer 114.

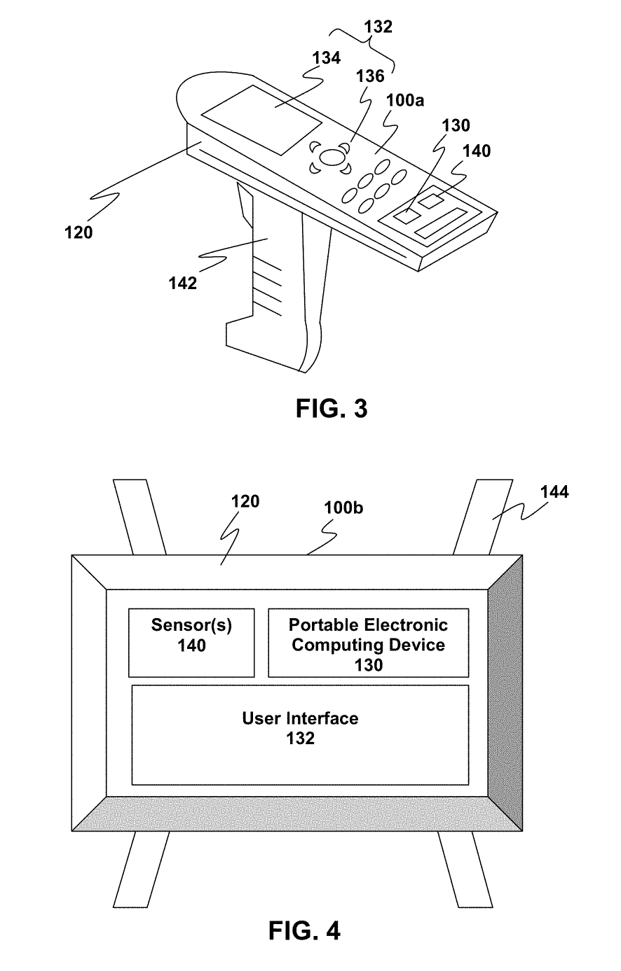

FIGS. 3 and 4 show examples of monitoring devices 100. Specifically, in FIG. 3, an example of a handheld monitoring device 100a is depicted. Representatives 112 can carry retailer-issued handheld devices like these or similar devices during their work day. In various embodiments, these devices 100a can include a housing 120, a portable electronic computing device 130 having a user interface 132 (including a display 134), as well as one or more sensors 140.

Handheld monitoring devices 100a embody a variety of useful devices and corresponding structures. In some embodiments, handheld monitoring devices 100a may include a business-issued or representative's own scanner, electronic mobile tablet, or smartphone. Accordingly, the housing 120 can take on various sizes, shapes, and materials suited to the needs of the type of device utilized. The housing 120 in FIG. 3 embodies a barcode scanner or similar device having a handle 142. The electronic computing device 130 that is coupled with and incorporated into the housing 120 includes a user interface 132, one or more processors, memory, corresponding electronic circuitry, and electrical components. The user interface 132 can include a display 134 and input buttons or controls 136, for example. Touch screen displays 134 and other types of user interface inputs are contemplated as well. Sensors 140 in the monitoring device 100a can include, for example: a gyroscope, gyro sensor, accelerometer, microphone, optical sensor, temperature sensor, position sensor, wireless communications system, or other components that generate data that can be analyzed to acquire activity data and identify possible customer interactions.

FIG. 4 depicts an example of a wearable monitoring device 100b. Wearable devices are especially useful for representatives 112 who often require their hands to be free to properly do their jobs. In various embodiments, these wearable monitoring devices 100b can include a housing 120, a portable electronic computing device 130 having a user interface 132, as well as one or more sensors 140. Wearable monitoring devices 100b can embody a variety of useful devices and corresponding structures. In some embodiments, wearable monitoring devices 100b can include a smart watch or an augmented reality headset. In some embodiments, wearable monitoring devices 100b may be strapped or otherwise secured, or adhered to a person's arm, leg, chest, shoes, skin or clothing. As in the handheld monitoring device 100a, the housing 120 can take on various sizes, shapes, and materials. The housing 120 in FIG. 4 embodies an arm-mounted scanner or similar device having mounting straps 144. Other structures for securing the monitoring device 100b are contemplated as well. An electronic computing device 130 is shown coupled with and incorporated into the housing 120, including a user interface 132, one or more processors, memory, corresponding electronic circuitry, and electrical components. Although not specifically shown, the user interface 132 can include a display and input buttons or controls. User interfaces 132 with touch screen displays and other types of inputs are contemplated as well. Sensors 140 in the monitoring device 100b can include, for example: a gyroscope, gyro sensor, accelerometer, microphone, optical sensor, temperature sensor, position sensor, wireless communications system, or other components that generate data that can be analyzed to acquire activity data and identify possible representative/customer interactions.

In wearable embodiments, like the one in FIG. 4, the monitoring device 100b can be worn, such as on an arm, hand or wrist of a representative 112. As the representative 112 carries out various tasks, the monitoring device 100b moves with the representative's arm, hand or wrist, and those movements (e.g., via a gyroscope of the handheld device) can be tracked and analyzed. Likewise, similar tracking and analyzing can be done with a handheld device like monitoring device 100a.

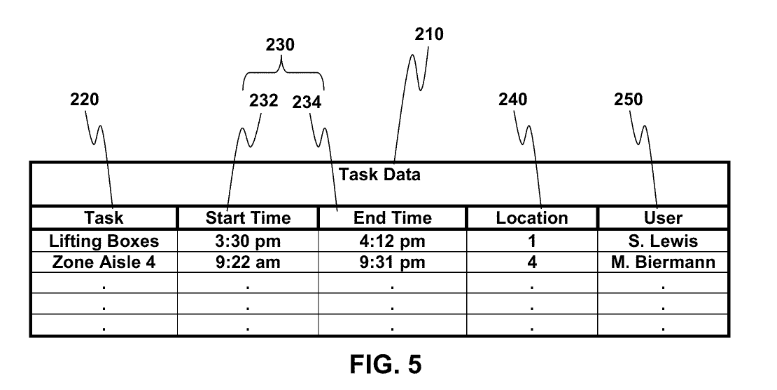

In FIG. 5, an example table of task data 210 for a task management system 200 of a customer interaction identification and analytics system 10 is shown. The task management system 200 generally provides information regarding the times, locations and types of gestures expected for the tasks 220 assigned to a representative, that are scheduled for completion. In general, the table of task data 210 lists an assigned set of responsibilities or tasks 220 for a representative 112 during a portion of his or her work day. The table of task data 210 is merely representative of tasks 220 that can be used by the customer interaction identification and analytics system 200 and is merely for explanatory purposes. Actual scheduled tasks 220 in a task management system 200 will generally be more extensive and specifically defined than the table depicted in FIG. 5.

In FIG. 5, the table of task data 210 lists: a task 220, a temporal reference 230 comprising of a start time 232 and end time 234, a location 240, and a user 250. In general, one reason this task data of the customer interaction identification and analytics system 200 is advantageous to the overall system 10 is that knowledge of the range of expected movements, gestures, and locations associated with a representative 112 during a time period helps to differentiate which gestures and movements are merely associated with expected scheduled task(s) 220 from those gestures and movements that tend to show an interaction with a customer 114.

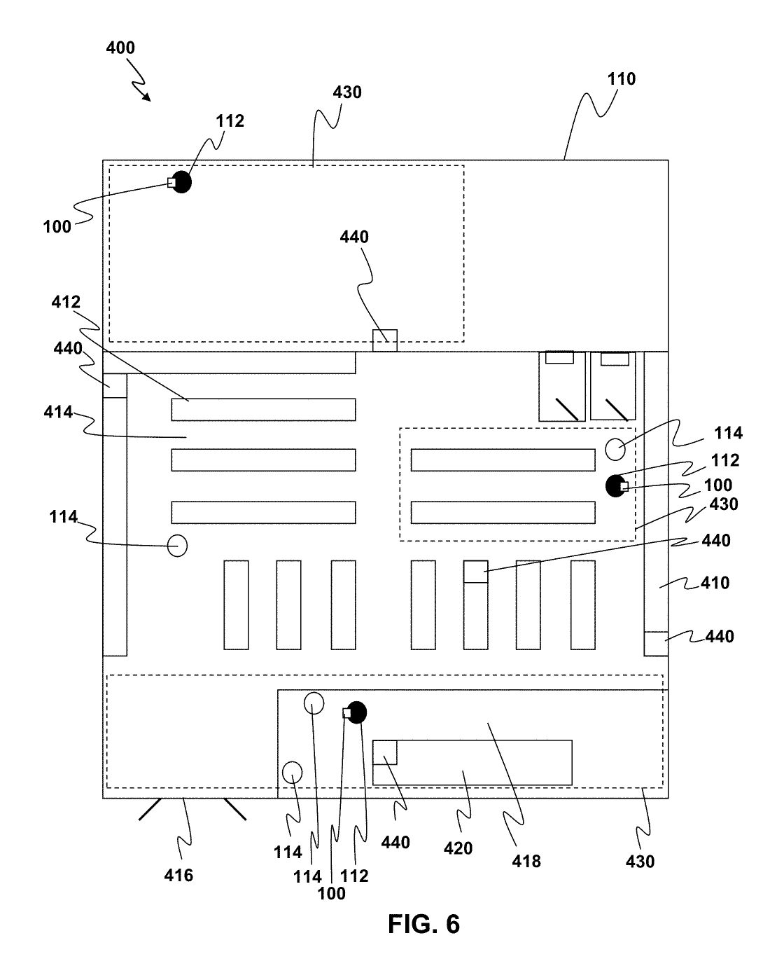

Tasks 220 can include a wide variety of jobs for representatives 112. Some examples of tasks 220 include: lifting boxes, zoning a particular aisle or section, sweeping the floor, stocking produce, gathering shopping carts, greeting customers, or any other assignment of duties. A temporal reference 230 can include a start time 232 and an end time 234 as shown, or may alternatively be a duration of time or other temporal reference. In some embodiments, the temporal reference 230 comprises a relative time. In some embodiments, a relative time can include a desired order of completion of a task 220. The location 240 can be defined to relate to a certain area, section, aisle, or other space within or around a retail environment. See FIG. 6 and the related discussion for additional details. In FIG. 5, the user 250 listed in the table contains identifying reference information of the representative assigned to the respective task 220. In FIG. 5, some information is shown with a numeric reference to an ID code, namely, the location 240. Fields such as task(s) 220 and user 250 could also be associated with or represented by an ID code or description identifier as well in some embodiments.

Referring to FIG. 6, a schematic diagram 400 of a defined retail environment 110 is shown. The diagram generally depicts walls 410, shelves 412, aisles 414, an entrance 416, a checkout area 418 and POS system 420 in and around which a customer interaction identification and analytics system 10 can be used. Monitoring devices 100 are shown throughout the retail environment 110 coupled with representatives 112. Customers 114 are depicted throughout the retail environment 110 as well. Examples of geofenced areas at locations 430a, 430b, and 430c (or more generally, locations 430) are shown that establish the limits for expected movement of the respective representative 112. The locations 430 are determined based upon and associated with the tasks 220 that the representative 112 is assigned. These locations 430 may be reflected in the location field 240 of the task data 210, for example. The locations 430 used in the system 10 can be defined and established through, and available via, any position or location defining technology or criteria. Technologies may include, but are not limited to GPS coordinates or geofencing, for example.

In operation, as a representative 112 moves through a retail environment 110 and makes various gestures and movements, the monitoring devices 100 sense his or her gestures and movements with sensors(s) 140 on wearable or handheld monitoring device(s) 100 and record activity data 500. This activity data 500 may include a location, a time stamp, or other information that is associated with a representative's activities.

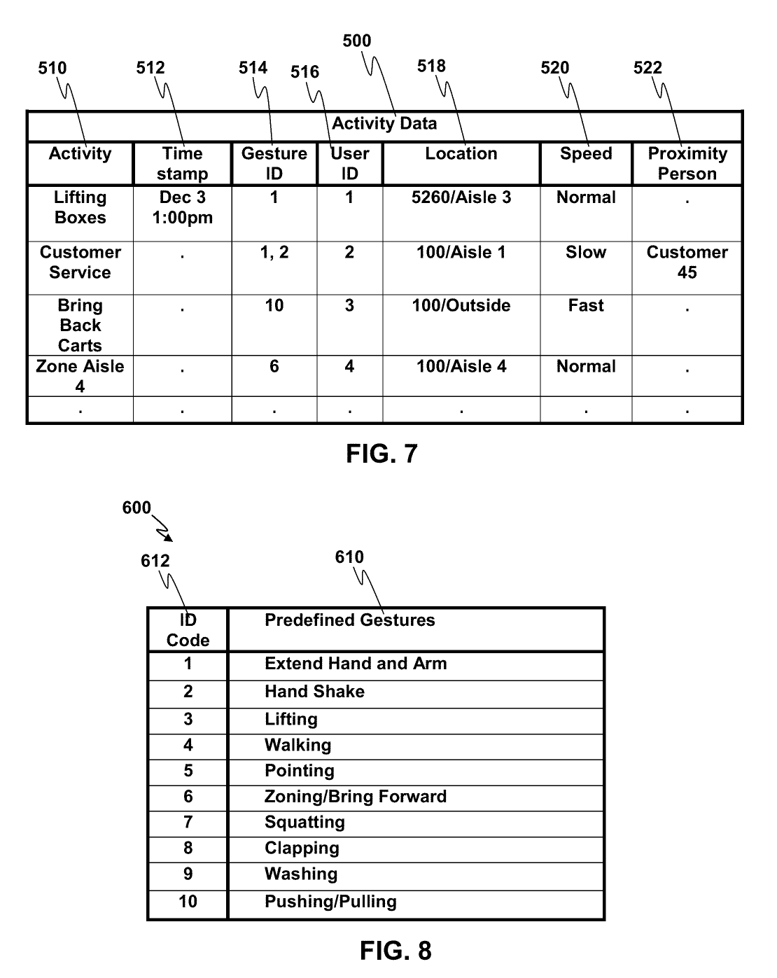

FIG. 7 provides an example table of activity data 500 provided by sensors 140 of monitoring devices 100. The activity data 500 of FIG. 7 lists: an activity 510, a time stamp 512, a gesture identification 514, a user identification 516, a location 518, a speed 520, and a proximity record 522 of any persons located nearby at the time. FIG. 7 is largely a table of activity data for general illustration and explanation purposes only. In some embodiments, activity data 500 sensed, can be compiled in a more raw form of sensed measurements and data received from the sensors 140 of the monitoring devices 100.

FIG. 8 provides an example key 600 of some predefined gestures 610 associated with an ID code 612 that can be identified in the records of activity data 500. For example, gestures 610 can include: extend hand and arm; hand shake; lifting; walking; pointing; zoning/bring forward; squatting; clapping; washing; and pushing/pulling. A database of predefined gestures 610 can include an extensive listing and grouping of gestures that will provide detailed information related to representative movements and activities.

Accordingly, data elements, comprising tasks 220, activity data 500, and associated related information, are communicated to or otherwise received by customer interaction identification and analytics module 300, which is communicatively coupled with the monitoring devices 100 and task management system 200. The customer interaction identification and analytics module 300 is able to analyze this information to determine if activities of representatives 112 are associated with customer interactions.

Specifically, embodiments of the customer interaction identification and analytics module 300 also include a gesture recognition database 310 coupled to the task management system 200 and monitoring devices 100 to receive and analyze activity data 500 and create a record of any activity 510 determined to be an interaction with a customer. This information then can be used to enhance customer experiences in retail stores or environments 110.

For example, representatives 112 carrying out routine tasks (e.g., selecting items from shelves) typically show more continuous movement of their arms. When a representative 112 is interacting with a customer 114, they may shake the customer's hand, raise their arm and point in the direction of something the customer 114 is looking for, or otherwise move (or not move) their arm(s) in ways that can be identified as consistent with customer interaction activities. In other words, the system 10, via hardware in the wearable or handheld monitoring device 100, can carry out physical gesture recognition and movement analytics.

In other embodiments, the system 10 can interact with an task management system 200, such that it knows where a representative 112 is supposed to be (to complete a particular task) and when, and via analytics can already know what sort of movements the representative 112 should be performing for that particular task. If different movements are detected, they could be analyzed for possible customer interaction activity. The system 10 also can interact with store layout (e.g., planogram) data such that it can obtain data about the location of shelves and the direction in which a representative 112 should be facing if the representative 112 is to be picking an item from a shelf, for example. If the representative 112 is facing away from the shelf and, e.g., a microphone sensor 140 picks up conversation, the system 10 could identify this as possible customer interaction activity.

In some embodiments, a microphone of the handheld or wearable monitoring device 100 is used as a sensor 140. The received activity data 500 would, accordingly, include recorded sound and data for comparison with gesture recognition database 310 that can include word or phrase recognition data. For example, the monitoring device 100 and sensor 140 can be used to identify key words or phrases that signal customer interaction, such as “Hello, how are you?”, “Can I help you?”, “Are you looking for something in particular?”, “Let me find that for you.”, and others.

In some embodiments, accelerometer data can be utilized. Specifically, a plurality of wearable monitoring devices 100b can include at least one sensor 140 that is an accelerometer, the received activity data 500 can be accelerometer data, and the data in the gesture recognition database 310 can include movement identification data.

In some embodiments, an accelerometer of a handheld or wearable monitoring device 100 can be used to track an representative's location via interaction with in-store sensors 440 (see FIG. 6). With such sensors 440, such as cameras or other systems (e.g., customer help buttons or kiosks distributed throughout stores), the system 10 can identify when a representative 112 is near a customer 114 or will encounter a customer 114 to identify situations in which the representative 112 could or should interact with a customer 114. For example, if a customer 114 pushes a help button in the dairy department, and the system 10 tracks a monitoring device 100 as being fifteen feet away from the help button, the representative 112 could be dispatched to help the customer 114. The system 10 could recognize that the representative 112 is close enough to the help button that the representative 112 should proactively approach the customer 114 to offer assistance. In some cases, a representative's proximity will be determined by established geo-fenced areas 430 around the representative 112. As described, geo-fenced areas 430 may serve as useful parameters for evaluating desirable representative 112 behavior. In another embodiment, the system 10 can also track customers 114 (e.g., via customer's smartphones with a retailer app, or anonymously via wifi, cameras or other in-store technology) and match customer location data with representative location data to identify instances of possible or actual representative/customer interactions. In some embodiments, a wearable or handheld monitoring device 100 can alert a representative 112 (e.g., with visual, audible and/or haptic feedback) that a customer 114 is nearby so that the representative 112 is encouraged in real time to interact and offer a greeting or assistance.

In some embodiments, the system 10 includes a customer location system comprising at least one sensor 440 arranged in the retail environment 110 to detect a presence and a location of a customer 114 in the retail environment 110. The customer interaction identification and analytics module 300 can be communicatively coupled with the customer location system to receive sensor data related to a detected presence and location of at least one customer 114 in the retail environment 110 and use the received sensor data in the analyzing to determine if the activity of the representative 112 is associated with an interaction with a customer 114 in the retail environment 110. In some embodiments, the customer interaction identification and analytics module 300 is configured to analyze the received sensor data relative to at least the temporal reference 230 and the location 240 associated with the at least one task 220. In some embodiments, the sensor includes a position sensor, and wherein the customer interaction identification and analytics module 300 is configured to analyze the received sensor data relative to activity data 500 from the position sensor of a sensed location of the representative 112.

In some embodiments, determinations of interactions with a customer 114 in the retail environment 110 by the customer interaction identification and analytics module 300 are followed by a query to the representative 112 of whether the activity was an interaction with a customer 114

Embodiments of the customer interaction identification and analytics module 300 generally rely upon algorithms to recognize gestures of representatives 112 in retail environments 110. To identify certain pre-defined gestures, algorithms are provided to watch sensor data reflecting the position of the arms of a representative 112 and placement of a representative 112 generally. For instance, the skeleton of the representative's arm/hands and positional data with velocity/vector can be tracked. As an arm is extended out in a straight manner with the hand in a vertical position, an arm extension group can be assigned. When the hand clasps with another object/hand and moves up and down several times, a hand shake is assigned. In other examples, gyroscopes and accelerometers can detect that a representative 112 is bending down, and assign that action to a squatting or bending down group.

Groups can be combined based on the sensors and assigned to a task as a sensor input. Handshake gestures can be a combination of extending the arm and clasping with up and down movement, which could be multiple gestures combined. Sensor data from a camera or a proximity sensor can be used to show a representative 112 is interacting with another person that might be a customer 114. This data may also show that the representative 112 did a pointing gesture for perhaps assisting the potential customer with the direction to a product or showing a product. Depth sensors can be used to watch representatives 112 that are grabbing products that are further back in the shelves and to bring them closer to be on the same front plane as the other products around it (i.e. zoning).

In some embodiments, multiple forms of data can be combined along with representative location. For example, this can help determine if a representative 112 was just working with a box or if the representative was working with a customer 114, and consider the time to complete things. In some embodiments, existing libraries can be used to handle raw sensor data and transform it into points of data where it can be measured for grouping to full gestures. Microsoft Kinect® is one example of a product with such existing libraries.

Analytics features of the customer interaction identification and analytics module 300 (e.g., an analytics engine that gathers data and information from the monitoring devices and other stores systems) can analyze data for particular representatives, teams, departments, stores, or other groups or categories. Analytics results can be used to provide feedback, incentivize or deincentivize interactions with customers, and for other purposes.

Analytics can enable activity and gesture data obtained to be used for feedback, training, and scoring of a representative 112. Template actions and thresholds for certain actions are defined to compare with real-time data of actual representatives 112 to determine matches of desired target activities. For example, we know what a handshake looks like (i.e., it is an act of an arm being extended out in a straight manner with the hand in a vertical position and a hand clasp with another object/hand and move up and down several times). When a desired target action, such as a handshake, is sensed, a point can be awarded to the associated representative 112 for doing that action. Points can then be collected for metrics. Different stores or retail environments 110 could set thresholds for how many desired target actions are expected and those representatives 112 that don't meet these thresholds would be identified for further training, consequences or review. Alternatively, outstanding representatives 112 would be recognized and awarded appropriately. This data could be used for training to show new representatives what level of interactivity with customers and number of desired target actions are expected.

In some embodiments, task management system 200 and/or customer interaction identification and analytics module 300 is located remote from the retail environment 110 (e.g., at a home office) and can be communicatively coupled with multiple locations of a retailer. In other embodiments, a task management system 200 and/or a customer interaction identification and analytics module 300 is co-located, at least in part, at the retail environment 110. In still other embodiments, some or all of the task management system 200 and customer interaction identification and analytics module 300 are coupled with or form part of a cloud-based computing environment. A cloud-based computing environment can comprise one in which data is stored on one or more physical servers that can be located in one or more locations. The one or more locations typically, but not necessarily, are remote from the data sources (e.g., system 10 and/or retail environment 110). The servers and other hardware and software associated with the cloud-based system can be owned by the retailer or by an external company, such as a hosting company, from which the retailer buys or rents storage space. In an embodiment, the cloud-based or some other suitable storage system comprising a database can store information. This information can be concatenated in a database entry, stored together in logical pools, or arranged in the database in some other suitable form.

In embodiments, the data obtained by customer interaction identification and analytics module 300 can be used to make determinations regarding representatives 112 and suggest changes related to a retailer or retail environment 110. These suggestions can be provided in a variety of ways. For example, system 10 can generate an instruction to management at a retail environment 110. This instruction can be provided electronically, such as via a computer or other electronic device. This instruction also can be provided manually, such as in a report or diagram related to a portion of the retail environment 110.

Customer interaction identification and analytics module 300 also can aggregate data for a particular representative 112. For example, customer interaction identification and analytics module 300 can determine that one representative 112 frequently has customer interactions across all tasks 220 assigned or if a representative 112 appears to avoid customer interactions. In another example, customer interaction identification and analytics module 300 can compare data for two representatives 112 who work at the same or different retail environments 110 and are assigned similar tasks. The data of one representative 112 may show that that representative's willingness to assist customers is preferred, which can be determined by correlating the data between locations. Appropriate rewards and incentives can, accordingly, be determined, even between different stores or retail environments.

In embodiments, customer interaction identification and analytics module 300 can make specific suggestions based on the data and analysis. In some embodiments, the customer interaction identification and analytics module 300 can additionally consider manual input from an analyst user. In these embodiments, the system 10 can further comprise a user interface (not depicted) communicatively coupled with customer interaction identification and analytics module 300. Via this user interface, a user can input additional data, criteria, or other information, and receive and interact with analysis, maps, data and other information from customer interaction identification and analytics module 300 and system 10 as a whole.

In general, the amount and type of data managed, processed and analyzed by customer interaction identification and analytics module 300 and system 10 is outside the capabilities of manual processing and beyond mere automation of tasks that have been or could be performed by hand. In particular, system 10 can access huge volumes of data, relating to large numbers of representatives 112 and retailers. This data can relate to data collected over time (e.g., weeks, months or even years) for a multitude of representatives 112 and locations. The hardware and software components of system 10 can analyze, correlate and transform this data into the meaningful result of a change of employee staffing levels, assignments, and incentives, among other things.

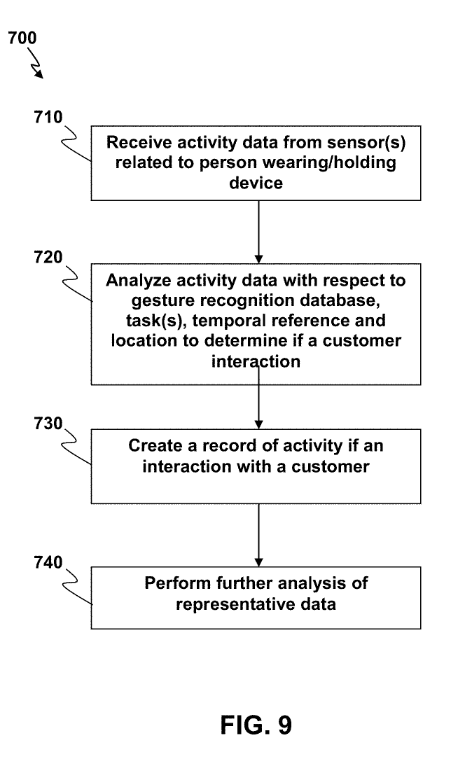

FIG. 9 shows a flowchart 700 providing an embodiment of actions provided via the customer interaction identification and analytics module 300. At 710, the customer interaction identification and analytics module 300 receives activity data 500 from at least one sensor 140 of one the monitoring devices 100. In general, the received activity data 500 is related to the representative 112 wearing or holding the one of the plurality of monitoring devices 100. At 720, the customer interaction identification and analytics module 300 analyzes the received activity data 500 with respect to data in its gesture recognition database 310, assigned task(s) 220, its temporal reference 230, and its location 240. In doing so, the module 300 is able to determine if the activity of the representative 112 is associated with an interaction with a customer 114 in the retail environment 110. In some cases, a step of verifying this determination by asking the representative 112 is performed. At 730, the customer interaction identification and analytics module 300 creates a record of any activity of the representative 112 determined to be an interaction with a customer 114 in the retail environment 110. Optionally, in some embodiments, at 740, further analysis of data of the representative 112 can be performed by the customer interaction identification and analytics module 300.

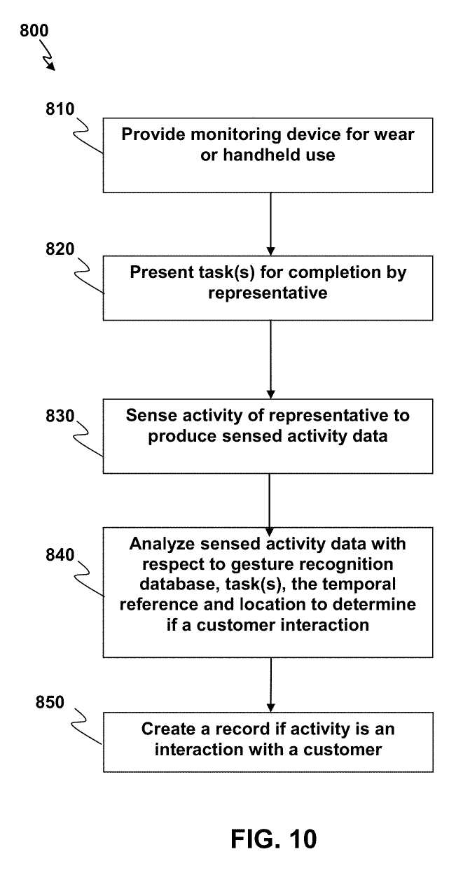

Referring to FIG. 10, a flowchart of one embodiment of a method 800 of identifying and analyzing customer interactions, related to system 10, is depicted. At 810, a monitoring device 100 configured for wear or handheld use is provided. The monitoring device 100 generally including: a housing 120, a portable electronic computing device 130 coupled with the housing 120 and having a user interface 132, and at least one sensor 140 to an representative 112 in a retail environment 110. At 820, at least one task 220 to be completed is presented by the representative 112 in a retail environment 110 on the user interface 132 of the monitoring device 100. The task(s) 220 are generally associated with a temporal reference 230 and a location 240 in the retail environment 110. At 830, activity of the representative 112 is sensed via the at least one sensor 140 to produce sensed activity data 500. At 840, the sensed activity data 500 is analyzed with respect to data in a gesture recognition database 310, the at least one task 220, the temporal reference 230 and the location 240 to determine if the activity of the representative 112 is associated with an interaction with a customer 114 in the retail environment 110. At 850, a record is created if the activity of the representative 112 is determined to be associated with an interaction with a customer 114 in the retail environment 110.

In embodiments, system 10 and/or its components or systems can include computing devices, microprocessors, modules and other computer or computing devices, which can be any programmable device that accepts digital data as input, is configured to process the input according to instructions or algorithms, and provides results as outputs. In an embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

In embodiments, the system or components thereof can comprise or include various modules or engines, each of which is constructed, programmed, configured, or otherwise adapted, to autonomously carry out a function or set of functions. The term “engine” as used herein is defined as a real-world device, component, or arrangement of components implemented using hardware, such as by an application-specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

One or more of the embodiments can include one or more localized Internet of Things (IoT) devices and controllers. As a result, in an embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system may be reduced significantly. For example, whenever a localized monitoring device allows remote transmission, secondary utilization of controllers secures data for other IoT devices and permits periodic asynchronous uploading of the summary data to the remote server. In addition, in an exemplary embodiment, the periodic asynchronous uploading of summary data may include a key kernel index summary of the data as created under nominal conditions. In an exemplary embodiment, the kernel encodes relatively recently acquired intermittent data (“KRI”). As a result, in an embodiment, KRI includes a source of substantially all continuously-utilized near term data. However, KRI may be discarded depending upon the degree to which such KRI has any value based on local processing and evaluation of such KRI. In an embodiment, KRI may not even be utilized in any form if it is determined that KRI is transient and may be considered as signal noise.

Furthermore, in an embodiment, the kernel can reject generic data (“KRG”) by filtering incoming raw data using a stochastic filter that provides a predictive model of one or more future states of the system and can thereby filter out data that is not consistent with the modeled future states which may, for example, reflect generic background data. In an embodiment, KRG incrementally sequences all future undefined cached kernels of data in order to filter out data that may reflect generic background data. In an embodiment, KRG incrementally sequences all future undefined cached kernels having encoded asynchronous data in order to filter out data that may reflect generic background data. In a further embodiment, the kernel can filter out noisy data (“KRN”). In an embodiment, KRN, like KRI, includes substantially a continuously utilized near term source of data, but KRN may be retained in order to provide a predictive model of noisy data.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A customer interaction identification and analytics system comprising:
a plurality of monitoring devices configured for wear or handheld use, each monitoring device including:
a housing,
a portable electronic computing device coupled with the housing and having a user interface, and
at least one sensor coupled with the portable electronic computing device and configured to sense activity data regarding a representative wearing or holding the monitoring device;
a task management system communicatively coupled with each of the plurality of monitoring devices to present, on the user interface, at least one task to be completed in a retail environment, the at least one task associated with a temporal reference and a location in the retail environment; and
a customer interaction identification and analytics module, comprising a gesture recognition database, communicatively coupled with the task management system and the plurality of monitoring devices to:
receive activity data from the at least one sensor of one of the plurality of monitoring devices, the received activity data related to the representative wearing or holding the one of the plurality of monitoring devices,
analyze the received activity data with respect to data in the gesture recognition database, the at least one task, the temporal reference and the location to determine if the activity of the representative is associated with an interaction with a customer in the retail environment, and
create a record of any activity of the representative determined to be an interaction with a customer in the retail environment.

2. The system of claim 1, wherein the plurality of monitoring devices each include at least one of a handheld scanner, a mobile tablet, a smartphone, a smartwatch, or an augmented reality headset.

3. The system of claim 1, wherein the at least one sensor is at least one of a gyro sensor, an accelerometer, a microphone, an optical sensor, a temperature sensor, or a position sensor.

4. The system of claim 3, wherein the at least one sensor comprises a microphone, the received activity data comprises recorded sound, and the data in the gesture recognition database comprises word or phrase recognition data.

5. The system of claim 3, wherein the plurality of monitoring devices comprise wearable devices, the at least one sensor comprises an accelerometer, the received activity data comprises accelerometer data, and the data in the gesture recognition database comprises movement identification data.

6. The system of claim 3, wherein the at least one sensor comprises an optical sensor, the received activity data comprises a photograph or a video, and the data in the gesture recognition database comprises facial recognition data. The system of claim 1, wherein the temporal reference comprises a relative time.

8. The system of claim 7, wherein the relative time comprises a desired order of completion of the at least one task.

9. The system of claim 1, further comprising a customer location system comprising at least one sensor arranged in the retail environment to detect a presence and a location of a customer in the retail environment, wherein the customer interaction identification and analytics module is communicatively coupled with the customer location system to receive sensor data related to a detected presence and location of at least one customer in the retail environment and use the received sensor data in the analyzing to determine if the activity of the representative is associated with an interaction with a customer in the retail environment.

10. The system of claim 9, wherein the customer interaction identification and analytics module is configured to analyze the received sensor data relative to at least the temporal reference and the location associated with the at least one task.

11. The system of claim 10, wherein the at least one sensor comprises a position sensor, and wherein the customer interaction identification and analytics module is configured to analyze the received sensor data relative to activity data from the position sensor of a sensed location of the representative.

12. The system of claim 1, wherein determinations of interactions with a customer in the retail environment by the customer interaction identification and analytics module are followed by a query to the representative of whether the activity was an interaction with a customer.

13. A method of identifying and analyzing customer interactions comprising:
providing a monitoring device configured for wear or handheld use, including: a housing, a portable electronic computing device coupled with the housing and having a user interface, and at least one sensor, to a representative in a retail environment;
presenting at least one task to be completed by the representative in a retail environment on the user interface, the at least one task associated with a temporal reference and a location in the retail environment;
sensing activity of the representative via the at least one sensor to produce sensed activity data;
analyzing the sensed activity data with respect to data in a gesture recognition database, the at least one task, the temporal reference and the location to determine if the activity of the representative is associated with an interaction with a customer in the retail environment; and
creating a record if the activity of the representative is determined to be associated with an interaction with a customer in the retail environment.

14. The system of claim 13, wherein the monitoring device includes at least one of a handheld scanner, a mobile tablet, a smartphone, a smartwatch, or an augmented reality headset.

15. The method of claim 13, wherein the at least one sensor is at least one of a gyro sensor, an accelerometer, a microphone, an optical sensor, a temperature sensor, or a position sensor.

16. The method of claim 15, wherein the at least one sensor comprises a microphone, the sensed activity data comprises recorded sound, and the data in the gesture recognition database comprises word or phrase recognition data.

17. The method of claim 15, wherein the monitoring device comprises a wearable device, the at least one sensor comprises an accelerometer, the sensed activity data comprises accelerometer data, and the data in the gesture recognition database comprises movement identification data.

18. The method of claim 15, wherein the at least one sensor comprises an optical sensor, the sensed activity data comprises a photograph or a video, and the data in the gesture recognition database comprises facial recognition data.

19. The method of claim 13, wherein the temporal reference comprises a relative time.

20. The method of claim 19, wherein the relative time comprises a desired order of completion of the at least one task.

21. The method of claim 13, further comprising detecting a presence and a location of a customer by at least one sensor arranged in the retail environment, wherein the analyzing further comprises using the detected presence and location of at least one customer in the retail environment determine if the activity of the representative is associated with an interaction with a customer in the retail environment.

22. The method of claim 21, wherein the analyzing further comprises comparing the detected presence and location of at least one customer in the retail environment with at least the temporal reference and the location associated with the at least one task.

23. The method of claim 22, wherein the at least one sensor of the portable electronic computing device comprises a position sensor, and wherein the analyzing comprises comparing the detected presence and location of at least one customer in the retail environment with data from the position sensor of a sensed location of the representative.

24. The method of claim 13, wherein determinations of interactions with a customer in the retail environment are followed by a query to the representative of whether the activity was an interaction with a customer.

25. The method of claim 13, wherein the monitoring device is wearable.
